(19) United States
(12) Patent Application Publication
(10) Pub. No.: US 2009/0246027 A1
(43) Pub. Date: Oct. 1, 2009

(54) WIND/FLUID TURBINE

(76) Inventor: Carl Johnson, Bear River, WY (US)

Correspondence Address: STETINA BRUNDA GARRED & BRUCKER, 75 ENTERPRISE, SUITE 250, ALISO VIEJO, CA, 92656, US

(21) Appl. No.: 12/060,780

(22) Filed: Apr. 1, 2008

(51) Int. Cl. F01D 5/14; F03D 9/00; F03D 3/06

(52) U.S. Cl. 416/197 A; 290/55; 416/243

(57) ABSTRACT

A wind turbine is provided which comprises a plurality of blades and a single venturi disposed at a central area of the plurality of blades. The single venturi redirects the wind from a concave side of an active blade to the concave sides of the other blades. Also, the single venturi reduces turbulent flow of air out of the venturi and redirects the flow of air against the adjacent blades.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

The present invention is related to a fluid (wind) turbine.

Environmentally friendly electrical generating systems have become a major issue in today's society due to the harmful effects of emissions from burned fuel causing a global warming effect. Accordingly, devices have been invented to harness energy in an environmentally friendly manner. Such devices include a wind operated turbine that converts wind energy into electricity and/or mechanical energy for various types of work.

Prior art wind turbines may have two concave shaped wings attached to a central shaft, as shown in FIG. 1. The wind blows against the concave side of the first wing and against a convex side of a second wing. The force applied against the concave side is greater than the force applied against the convex side. Accordingly, the wind pushes against the wings and rotates the shaft. The rotating shaft may be coupled to a generator to generate electricity. Unfortunately, prior art wind turbines are inefficient at converting wind energy into electricity. An example of prior art wings of a turbine is described in U.S. Pat. No. 4,005,947 (hereinafter the '947 patent).

To improve upon the basic design of the winged wind turbine, the prior art wing turbines also include an offset wings configuration, as shown in FIG. 2. In this example, the wind flows against the concave side of one of the wings and is redirected to the concave side of the following wing. The redirected wind pushes against the concave side of the following wing to help increase the pressure against the concave side of the following wing. This reduces the pressure difference between the concave and convex sides of the following wings thereby assisting in the rotation of the shaft.

The '947 patent also discusses an alternative embodiment that more efficiently redirects the wind against the following blade. In particular, as understood, the '947 patent introduces a central vein which is fixed in relation to the wings. The central vein and the wings provide flow paths to redirect the wind against the other blades.

The wind turbine discussed herein is an alternative embodiment which aids in efficiently converting wind energy into electrical energy or mechanical energy.

### BRIEF SUMMARY

The wind turbine discussed herein addresses the needs discussed above, discussed below and those that are known in the art.

The wind turbine may comprise a rotor assembly comprising a plurality of blades symmetrically disposed about a rotating axis of the rotor assembly. The wind may blow against the plurality of blades and be operative to rotate the plurality of blades. A venturi may be disposed at a central area of the blades such that wind exiting the venture is redirected in a less turbulent manner to adjacent blades.

In an aspect of the wind turbine, the leading edges of the blades may be folded.

In another aspect of the wind turbine, the leading portions and trailing portions of the blades may be tangentially aligned to a circle defined by the leading edges and the trailing edges of the blades.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is an illustration of a prior art winged turbine;

FIG. 2 is an illustration of a prior art winged turbine with offset wings to redirect wind to a concave side of a following wing;

FIG. 3 is an illustration of a prior art winged turbine with offset wings and a central vein to redirect wind to adjacent blades;

FIG. 4 is a perspective view of a wind turbine;

FIG. 5 is a top cross sectional view of a rotor assembly of the wind turbine shown in FIG. 4;

FIG. 6 is a top cross sectional view of a blade with bent and a crimped leading portion.

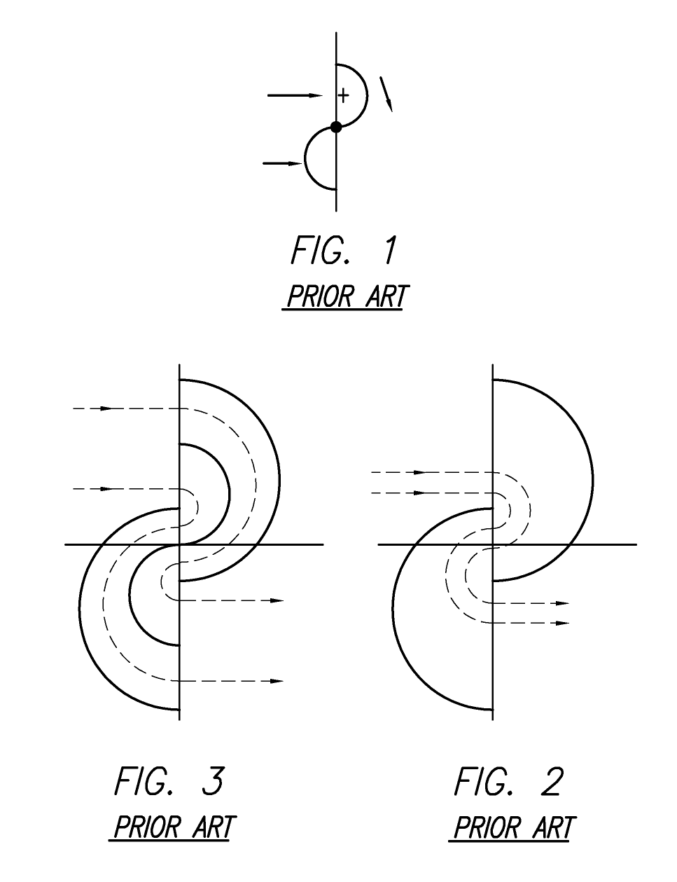

### DETAILED DESCRIPTION

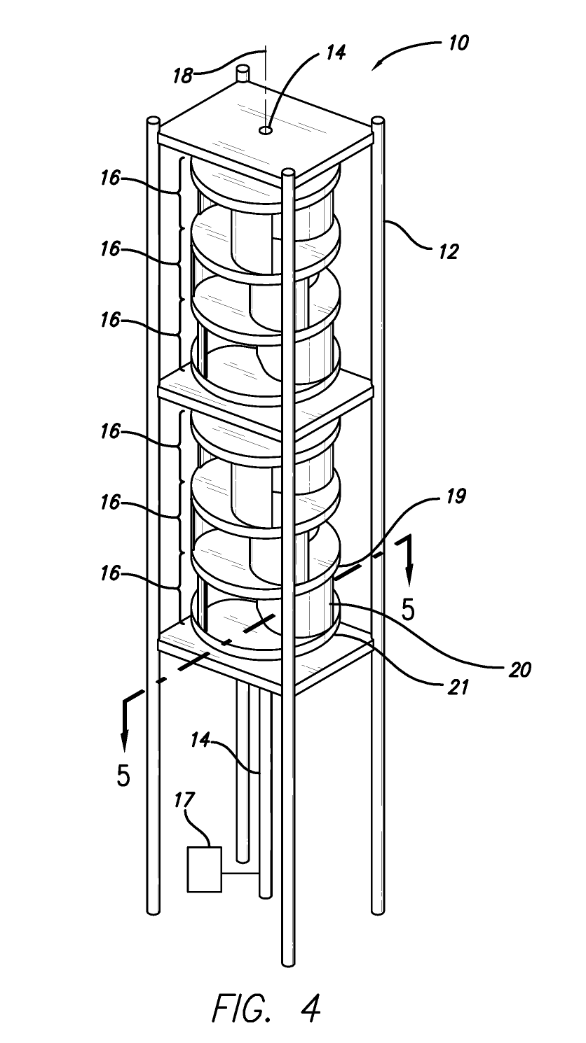

Referring now to FIG. 4, a turbine 10 is illustrated. The turbine 10 may be operative to rotate a shaft 14 for generating electricity or other types of work. The turbine 10 will be discussed in relation to the flow of wind across the turbine 10 but may be applicable to other types of fluid such as liquid, water, etc. Accordingly, the various aspects of the turbine 10 disclosed herein are also applicable to other types of fluid media.

The turbine 10 may comprise a frame 12, a rotatable shaft 14 and a rotor assembly 16. A plurality of rotor assemblies may be stacked in two sets of three rotor assemblies as shown in FIG. 4. The rotatable shaft 14 may be mounted to the frame 12 with bearings to allow relatively frictionless rotation of the shaft 14 to the frame 12. The rotor assembly 16 may be mounted to the shaft 14 at various angular orientations. The turbine 10 may be located in any area but is preferably located in windy areas in order to provide sufficient wind energy to the turbine 10. The turbine 10 may convert the wind energy into electricity or other types of work. Generally, wind may blow against the rotor assembly 16 thereby rotating the rotor assembly 16. Since the shaft 14 is attached to the rotor assembly and aligned to a rotating axis 18 of the rotor assembly 16, the rotation of the rotor assembly 16 is operative to also rotate the shaft 14. The shaft 14 may be coupled to a generator 17 to generate electricity. Alternatively, the shaft may be directly attached to a device to directly provide energy to the device for operating the device.

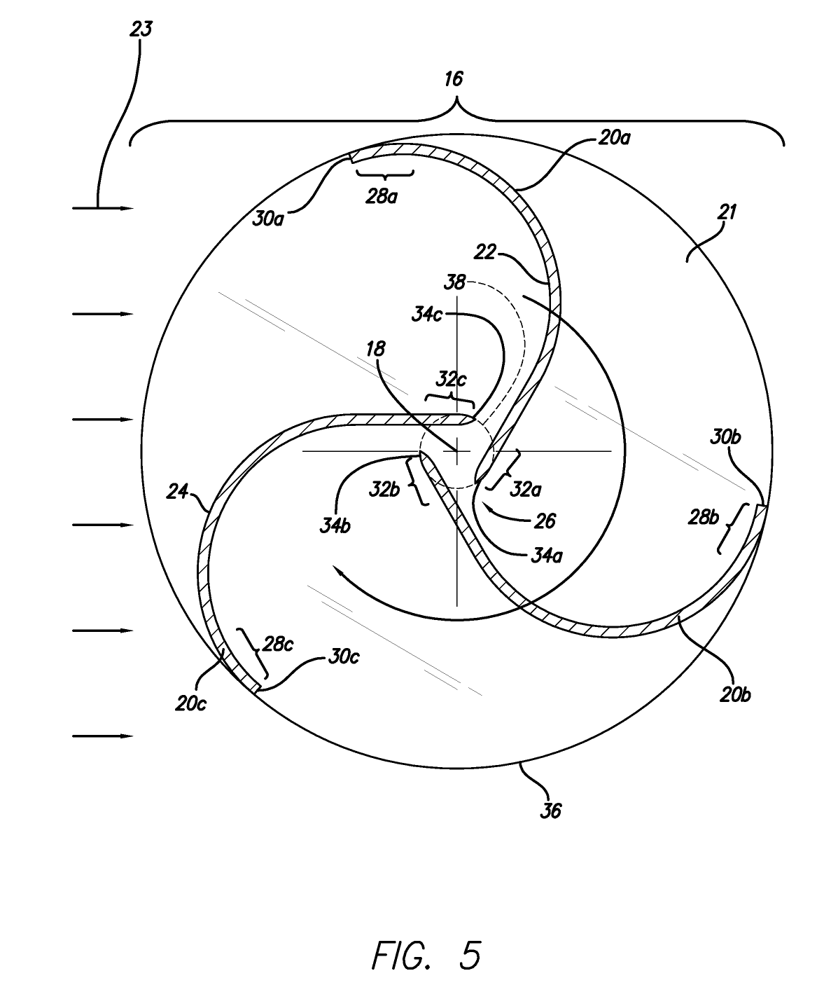

The rotor assembly 16 may have a plurality of blades 20 symmetrically positioned about a rotating axis 18. Upper and lower plates 19, 21 may be attached to the upper and lower edges of the blades 20, as shown in FIG. 4. As shown in FIG. 5, the rotor assembly 16 may have three blades 20a, b, c which are positioned about the rotating axis 18 in a symmetrical manner. During use, the wind blows against the blades 20 of the rotor assembly 16. When the wind contacts the concave side 22, the wind pushes against the blade 20 with a force X. When the wind contacts the convex side 24 of the blades 20, the wind pushes against the blade with a force Y. The force X is generally greater than the force Y. Accordingly, the rotor assembly 16 shown in FIGS. 4 and 5 rotates in a clockwise direction. Although the rotor assembly 16 will be discussed in relation to a clockwise rotating rotor assembly, it is contemplated that the various aspects of the turbine 10 may be variously embodied and employed in a counter clockwise rotating rotor assembly 16. To this end, the blades 20 may be fabricated in a mirror configuration.

During operation, the wind simultaneously blows against the active blade and a following blade. In FIG. 5, the arrows 23 represent wind. The active blade is the blade 20a upon which the wind 23 directly blows against the concave side 22. The following blade is blade 20c immediately adjacent to the active blade on the counter clockwise side of the active blade. When the wind 23 contacts the concave side 22 of the active blade, the wind 23 is redirected toward the center of the rotor assembly 16. The wind 23 enters a venturi 26 which redirects the wind 23 against the concave sides 22 of the following blade 20c and a preceding blade 20a. The redirected wind increases the pressure applied against the concave sides 22 of the following blade and the preceding blade. As the rotor assembly 16 rotates in the clockwise direction, the wind produces a positive pressure against the concave side 22 of the active blade. The throughput of wind through the venture is less than the speed of the wind thereby pressure builds on the concave side 22 of the active blade. Conversely, the concave sides 22 of the following blade and the preceding blade experience a negative pressure. To reduce the negative pressure or to provide a positive pressure against the concave sides 22 of the following blade and the preceding blade, the wind blown against the concave side 22 of the active blade is redirected by the venturi 26 to the concave sides 22 of the following blade and the preceding blade.

As the wind enters the venturi 26, the wind accelerates through the narrow section of the venturi 26. The venturi 26 shown in FIG. 5 is a three way venturi but a two way venturi for a two bladed rotor assembly or a multi-way venturi for a multi-bladed rotor assembly is contemplated. The wind is then redirected toward the concave sides 22 of the following blade and the preceding blade but is slowed down by the widening or expansion of the venturi's exit portion. The wind is slowed down to reduce the turbulent flow of air through the venturi 26 and provide more laminar flow of air against the concave sides 22 of the following and preceding blades. The flow of air against the concave sides 22 of the following and preceding blades provide rotational thrust on the blades 24.

The blades 20 may each define a leading portion 28, leading edge 30, trailing portion 32 and a trailing edge 34. The leading edges 30 may be equally distantly spaced a part from each other and also equally distantly spaced from the rotating axis 18 of the rotor assembly 16. The leading edges 30a, b and c of the blades 20a, b and c may define a circle which is aligned to the outer perimeter 36 of the lower plate 21, as shown in FIG. 5. The leading portions 28a, b and c of the blades 20a, b and c may extend tangentially from the outer perimeter 36 and curve inward toward the central area of the rotor assembly 16.

Similarly, the trailing edges 34a, b and c of the blades 20a, b and c may be equally distantly spaced apart from each other as well as from the rotating axis 18. The trailing edges 34a, b and c of the blades 20a, b and c may define a circle 38. As the blades 20a, b and c curve inward toward the central area of the rotor assembly 16, the trailing portions 32a, b and c of the blades 20a, b and c may be tangentially aligned to the circle 38.

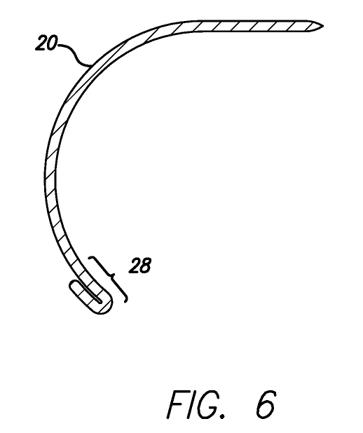

In an aspect of the turbine 10, the leading portions 28a, b, c of the blades 20a, b, c may be bent and crimped, as shown in FIG. 6. The bent and crimped leading portion provides reinforcement or additional strength along a height of the blade so as to prevent the leading portion from bending in high winds or at high rotational speeds. In high winds, the upper and lower points of the leading portions are fixedly attached to the upper and lower plates 19, 21, as shown in FIG. 4. However, the high winds may place an excessive amount of pressure against the middle of the leading portions 28. The excessive pressure may tend to bend the leading portions. Fortunately, the leading portion 28 may be reinforced by bending and crimping the leading portion 28 of the blade 20 (see FIG. 6) to prevent deformation of the leading portion 28.

In an aspect of the turbine 10, the venturi 26 may be sized to provide optimum performance and efficiency of the blades 20. More particularly, the venturi 26 may be defined by the circle 38 (see FIG. 5). The trailing edges 34a, b, c of the blades 20a, b, and c may be aligned to the circle 38 to maintain symmetry and balance of the rotating blades 20a, b, and c to the rotating axis 18. Based on the specific configuration of the blades 20a, b, and c and other factors, the size of the venturi 26 defined by the trailing edges 34a, b, c and the trailing portions 32a, b, c, the size of the circle 38 to which the trailing edges 34a, b, c are aligned to may be enlarged or reduced to provide the optimum performance and efficiency of the rotating blades 20a, b, and c.

The above description is given by way of example, and not limitation. Given the above disclosure, one skilled in the art could devise variations that are within the scope and spirit of the invention disclosed herein, including various ways of incorporating the various aspects of the turbine 10 to turbines in relation to other fluid media. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A wind turbine for generating energy, the turbine comprising:
a rotatable shaft; and
a rotor assembly attached to the shaft and operative to rotate the shaft due to wind blowing against the wind turbine, the rotor assembly comprising:
at least three curved shaped blades rotatable about the rotatable shaft, each of the blades defining a convex side and a concave side, the blades symmetrically oriented about the rotatable shaft, adjacent blades defining a cavity; and
a single venturi centrally disposed about the blades and providing fluid communication between the cavities of adjacent blades.

2. The turbine of claim 1 wherein wind enters a front side of the rotor assembly contacting an active blade to rotate the rotor assembly and the shaft, the wind redirected to the concave sides of a preceding blade and a following blade to at least reduce a negative pressure on the concave sides of the preceding or following blades.

3. The turbine of claim 1 wherein leading portions of the blades are generally tangential to a circle defined by leading edges of the blades.

4. The turbine of claim 3 wherein trailing portions of the blades are generally tangential to a circle defined by trailing edges of the blades.

5. The turbine of claim 1 wherein leading portions of the blades are folded.

6. The turbine of claim 1 wherein the venturi reduces turbulent flow of air as the air travels against the concave sides of the preceding and following blades.
